(19) United States
(12) Patent Application Publication
(10) Pub. No.: US 2023/0348708 A1
(43) Pub. Date: Nov. 2, 2023

(54) TOUGHENED RESIN COMPOSITION

(71) Applicant: ITEQ CORPORATION, Hsinchu County (TW)

(72) Inventors: Sheng-Yen WU, Hsinchu County (TW); Tzu-Fang CHEN, Hsinchu County (TW); Po-Kai TSENG, Hsinchu County (TW); Yu-Chieh HSU, Hsinchu County (TW); Te-Chieh LI, Hsinchu County (TW); Shao-Wei YU, Hsinchu County (TW)

(21) Appl. No.: 18/075,967

(22) Filed: Dec. 6, 2022

(30) Foreign Application Priority Data
Apr. 29, 2022 (CN) 202210474164.2

(51) Int. Cl. C08L 63/00; C08J 5/24; B32B 5/02; B32B 5/26; B32B 15/14; B32B 15/20

(52) U.S. Cl. CPC C08L 63/00; C08J 5/244; B32B 5/02; B32B 5/26; B32B 15/14; B32B 15/20; C08J 2363/00; C08J 2451/06; C08J 2479/08; C08L 2205/03; B32B 2260/023; B32B 2260/046; B32B 2262/101; B32B 2250/05; B32B 2250/40

(57) ABSTRACT

The present disclosure provides a toughened resin composition, which includes: (A) a toughened and modified compound, which includes a polybenzoxazine compound, an anhydride grafted olefin polymer, and a diisocyanate compound; and (B) a thermosetting polymer; wherein, in the toughened and modified compound, the diisocyanate compound forms a bond with the polybenzoxazine compound and the anhydride grafted olefin polymer, respectively. The present disclosure has high toughness and excellent mechanical properties; thus, it may have a wide range of applications in the fields of electronics, aerospace, and the like.

### BACKGROUND OF THE DISCLOSURE

### Technical Field

The present disclosure relates to a toughened resin composition, in particular to a resin composition having an olefin polymer toughened and modified polybenzoxazine compound.

### Description of Related Art

Polybenzoxazine is a kind of nitrogen-containing thermosetting resin with a structure similar to phenolic resin, and its performance is better than that of traditional phenolic resin. Benzoxazine compounds are generally prepared from phenolic compounds, primary amines and formaldehyde compounds through the Mannich reaction. Under the action of heating or catalyst, the reaction results in ring-opening polymerization to form a network structure similar to phenolic resin, which can also be called benzoxazine resin.

Compared with traditional phenolic resins, benzoxazine resins have many advantageous properties, such as: low moisture absorption rate, good heat resistance, good mechanical properties, good electrical properties, good flame retardant properties; and no small molecule by-products are released during the polymerization process, so the volume shrinkage rate is low. Therefore, benzoxazine resins are widely used in the fields of composite matrix resins, solvent-free impregnating paints, electronic packaging materials, flame retardant materials and electrical insulating materials.

Although benzoxazine resins have many advantages mentioned above, however, after benzoxazine undergoes thermal ring-opening polymerization, its mechanical properties are brittle, which is an obstacle to be overcome in its application and development.

### SUMMARY OF THE DISCLOSURE

In view of this, the inventors have devoted themselves to the aforementioned related art, researched intensively try to solve problems of improving the mechanical properties of the polybenzoxazine, so that its resin composition has high toughness and excellent mechanical properties.

The main purpose of the present disclosure is to provide a toughened resin composition, including: (A) a toughened and modified compound, which includes a polybenzoxazine compound, an anhydride grafted olefin polymer, and a diisocyanate compound; and (B) a thermosetting polymer; wherein, in the toughened and modified compound, the diisocyanate compound forms a bond with the polybenzoxazine compound and the anhydride grafted olefin polymer, respectively.

In some embodiments, (A) the toughened and modified compound is 30 to 50 parts by weight; and/or (B) the thermosetting polymer is 8 to 15 parts by weight.

In some embodiments, the thermosetting polymer is bismaleimide (BMI) resin, bismaleimide triazine polymer, cyanate ester polymer, benzocyclobutene polymer, or phenolic resin.

In some embodiments, the polybenzoxazine compound is a bisphenol type polybenzoxazine or a bisamine type polybenzoxazine.

In some embodiments, the polybenzoxazine compound is selected from the group consisting of bisphenol A type benzoxazine, bisphenol F type benzoxazine, bisphenol S type benzoxazine, diaminodiphenylmethane type benzoxazine, diaminodiphenyl ether type benzoxazine and polybenzoxazine with polyimide.

In some embodiments, the anhydride grafted olefin polymer includes: styrene-ethylene/butylene-styrene copolymer grafted maleic anhydride, polypropylene grafted maleic anhydride or polyethylene grafted maleic anhydride.

In some embodiments, the diisocyanate compound is selected from the group consist of trimethylene diisocyanate, tetramethylene diisocyanate, pentamethylene diisocyanate, hexamethylene diisocyanate, 1,2-propylene diisocyanate, 1,3-butylene diisocyanate, dodecamethylene diisocyanate, 2,4,4-trimethylhexamethylene diisocyanate, 1,3-cyclopentene diisocyanate, 1,3-cyclohexane diisocyanate, 1,4-cyclohexane diisocyanate, methylene dicyclohexyl diisocyanate, isophorone diisocyanate, hydrogenated diphenylmethane diisocyanate, hydrogenated xylylene diisocyanate, hydrogenated toluene diisocyanate, hydrogenated tetramethyl xylylene diisocyanate, phenylene diisocyanate, 2,4-toluene diisocyanate, 2,6-toluene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate and xylylene diisocyanate.

In some embodiments, the toughened resin composition further including: a filler, and the filler is selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene.

In some embodiments, the filler is 40 to 60 parts by weight.

In some embodiments, the toughened resin composition further including: a toughening resin of 10 to 15 parts by weight.

Therefore, the toughened resin composition provided by the present disclosure includes a toughened and modified compound, which is a polybenzoxazine compound toughened and modified by an olefin polymer, and formed a bond with a diisocyanate compound. As a result, the toughened resin compound of the present disclosure has excellent heat resistance and mechanical properties, and low water absorption. The toughened resin compound of the present disclosure has excellent heat resistance, low expansion, high dimensional stability, high mechanical strength and high toughness, and can be blended with other thermosetting polymers, inorganic fillers or fibers to form composite materials. Thus, the toughened resin compound has wide range of application in the fields of electronic, aerospace and the like.

### BRIEF DESCRIPTION OF THE DRAWINGS

The details of one or more embodiments of the subject matter described in the present disclosure are set forth in the accompanying drawing and the description below. Other features, aspects, and advantages of the subject matter of this disclosure will become apparent from the description, drawing, and claims, in which:

FIG. 1 is the reaction formula schematic diagram, in accordance with some embodiments.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

Unless otherwise defined, all technical and scientific terms used herein have the same meaning as understood by one of ordinary skill in the art to which this disclosure belongs. As used in this application, the following terms have the following meanings.

As used herein, terms such as “first,” “second,” “third,” “fourth,” and “fifth” describe various elements, components, regions, layers, and/or section, these elements, components, regions, layers and/or sections should not be limited by these terms. These terms are only used to distinguish one element, component, region, layer, or section from another. Terms such as “first,” “second,” “third,” “fourth,” and “fifth” when used herein do not imply a sequence or order unless the context clearly dictates otherwise.

Unless otherwise stated, “or” as used herein means “and/or”. As used herein, the terms “comprise,” “have,” “contain,” and “include” are intended to not exclude the presence or addition of one or more other components, steps, operations and/or elements to the described components, steps, operations and/or elements; similarly, “comprise,” “have,” “contain,” and “include” described herein can be substituted for each other without limitation. The terms “a,” “an,” and “the” are understood to encompass the plural as well as the singular (ie, at least one). The expression “one or more” means “at least one” and thus may include an individual characteristic or mixtures/combinations.

The present disclosure provides a toughened resin composition, including: (A) a toughened and modified compound, which includes a polybenzoxazine compound, an anhydride grafted olefin polymer, and a diisocyanate compound; and (B) a thermosetting polymer; wherein, in the toughened and modified compound, the diisocyanate compound forms a bond with the polybenzoxazine compound and the anhydride grafted olefin polymer, respectively.

The “polybenzoxazine compound (also abbreviated as BZ)” described herein is a kind of nitrogen-containing thermosetting resin with a structure similar to phenolic resin, and its performance is better than that of traditional phenolic resin. Benzoxazine compounds are six-membered heterocyclic compound systems composed of oxygen atoms and nitrogen atoms, and are generally prepared from phenolic compounds, primary amines and formaldehyde compounds through the Mannich reaction. Under the action of heating or catalyst, the reaction results in ring-opening polymerization to form a network structure similar to phenolic resin, which can also be called benzoxazine resin. In some embodiments, the polybenzoxazine compound is a bisphenol type polybenzoxazine or a bisamine type polybenzoxazine. In some embodiments, the polybenzoxazine compound is at least one selected from the group consisting of bisphenol A type benzoxazine (BPA-BZ), bisphenol F type benzoxazine (BPF-BZ), bisphenol S type benzoxazine (BPS-BZ), diaminodiphenylmethane type benzoxazine (DDM-BZ), diaminodiphenyl ether type benzoxazine (ODA-BZ) and polybenzoxazine with polyimide.

The “anhydride grafted olefin polymer” described herein is used as a toughening agent and has excellent electrical properties and good impact resistance properties. In some embodiments, the olefin polymer of the toughening agent of the present disclosure is grafted with maleic anhydride, which has good compatibility with the base resin and may achieve the modification effect. In some embodiments, examples of the toughening agent include, but are not limited to, styrene-ethylene/butylene-styrene copolymer grafted maleic anhydride (SEBS-g-MA), polypropylene grafted maleic anhydride (PP(Poly Propylene)-g-MA) or polyethylene grafted maleic anhydride (PE(Poly Ethylene)-g-MA).

The “diisocyanate compound” described herein is used as a modifier. In the toughened and modified compound, there is a bond between the diisocyanate of the diisocyanate compound and the polybenzoxazine compound and the acid anhydride of the toughening agent, respectively, so as to achieve chemical modification. Cyanate ester compounds may increase the reactive functional groups in the resin structure, thereby increasing the crosslinking density of the epoxy cured product and improving the heat resistance. Examples of the cyanate ester compound include, but are not limited to, a multifunctional aliphatic isocyanate compound, a multifunctional alicyclic isocyanate compound, a multifunctional aromatic isocyanate compound, such as trimethylene diisocyanate, tetramethylene diisocyanate, pentamethylene diisocyanate, hexamethyl ene diisocyanate, 1,2-propylene diisocyanate, 1,3-butylene diisocyanate, dodecamethylene diisocyanate, 2,4,4-trimethylhexamethylene diisocyanate, 1,3-cyclopentene diisocyanate, 1,3-cyclohexane diisocyanate, 1,4-cyclohexane diisocyanate, methylene dicyclohexyl diisocyanate, isophorone diisocyanate, hydrogenated diphenylmethane diisocyanate, hydrogenated xylylene diisocyanate, hydrogenated toluene diisocyanate, hydrogenated tetramethyl xylylene diisocyanate, phenylene diisocyanate, 2,4-toluene diisocyanate, 2,6-toluene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, xylylene diisocyanate and the like. In some embodiments, the modifier includes: isophorone diisocyanate (IPDI), methylene dicyclohexyl diisocyanate (hydrogenated MDI or HMDI) or hexamethylene diisocyanate (HDI).

In some embodiments, the toughened and modified compound of the present disclosure includes a compound selected from the group consist of isophorone diisocyanate modified styrene-ethylene/butylene-styrene copolymer grafted maleic anhydride toughened polybenzoxazine compound (IPDI/SEBS-g-MA/BZ), methylene dicyclohexyl diisocyanate modified styrene-ethylene/butylene-styrene copolymer grafted maleic anhydride toughened polybenzoxazine compound (HMDI/SEBS-g-MA/BZ), hexamethylene diisocyanate modified styrene-ethylene/butylene-styrene copolymer grafted maleic anhydride toughened polybenzoxazine compound (HDI/SEBS-g-MA/BZ), isophorone diisocyanate modified polypropylene grafted maleic anhydride toughened polybenzoxazine compound (IPDI/PP-g-MA/BZ), methylene dicyclohexyl diisocyanate modified polypropylene grafted maleic anhydride toughened polybenzoxazine compound (HMDI/PP-g-MA/BZ), hexamethylene diisocyanate modified polypropylene grafted maleic anhydride toughened polybenzoxazine compound (HDI/PP-g-MA/BZ), isophorone diisocyanate modified polyethylene grafted maleic anhydride toughened polybenzoxazine compound (IPDI/PE-g-MA/BZ), methylene dicyclohexyl diisocyanate modified polyethylene grafted maleic anhydride toughened polybenzoxazine compound (HMDI/PE-g-MA/BZ) and hexamethylene diisocyanate modified polyethylene grafted maleic anhydride toughened polybenzoxazine compound (HDI/PE-g-MA/BZ).

In some embodiments, in the toughened resin composition of the present disclosure, (A) the toughened and modified compound is about 30 to 50 parts by weight, for example but not limited to: 30 parts by weight, 32 parts by weight, 34 parts by weight, 36 parts by weight, 38 parts by weight parts by weight, 40 parts by weight, 42 parts by weight, 44 parts by weight, 46 parts by weight, 48 parts by weight, 50 parts by weight or between any two of the preceding values; and/or (B) the thermosetting polymer is about 8 to 15 parts by weight, for example but not limited to: 8 parts by weight, 9 parts by weight, 10 parts by weight, 11 parts by weight, 12 parts by weight, 13 parts by weight, 14 parts by weight, 15 parts by weight or between any two of the preceding values.

Examples of the thermosetting polymer of the present disclosure include, but are not limited to, bismaleimide (BMI) resin, bismaleimide triazine polymer, cyanate ester polymer, benzocyclobutene polymer, or phenolic resin. In some embodiments, the thermosetting polymer of the present disclosure is BMI resin. BMI resin has a carbonyl group and a nitrogen-containing epoxy resin, and is cured by the unsaturation of the end groups during processing and molding, and no volatile substances are generated during the curing process, which will facilitate the processing and molding of composite materials.

In some aspects, the toughened resin composition of the present disclosure may further include: a filler, a toughened resin and/or a solvent.

In some embodiments, the filler is an inorganic filler, for example but not limited to, selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene. In some embodiments, the filler is about 40 to 60 parts by weight, for example but not limited to: 40 parts by weight, 42 parts by weight, 44 parts by weight, 46 parts by weight, 48 parts by weight, 50 parts by weight, 52 parts by weight, 54 parts by weight, 56 parts by weight, 58 parts by weight, 60 parts by weight or between any two of the foregoing values.

In some embodiments, the solvent is selected from the group consist of toluene, γ-butyrolactone, methyl ethyl ketone, cyclohexanone, butanone, acetone, xylene, methyl isobutyl ketone, N,N-dimethylformamide, N,N-dimethylacetamide, N-methylpyrrolidone and combinations thereof.

In some embodiments, the toughened resin is, for example but not limited to, a core-shell polymer and/or a polybutadiene resin. The core-shell polymer is such as core shell rubber (CSR). The polybutadiene resin is, for example, a polybutadiene homopolymer or a butadiene-styrene copolymer. In some embodiments, the toughening resin is about 10 to 15 parts by weight, such as but not limited to: 10 parts by weight, 11 parts by weight, 12 parts by weight, 13 parts by weight, 14 parts by weight, 15 parts by weight or between any two of the preceding values.

The toughened resin composition not only forms the chemical modification of polyimide bond through the reaction of isocyanate and acid anhydride, but also through the modification of olefin polymer and polybenzoxazine compound, to achieve the effect of toughening improvement, so that the toughened resin composition has high toughness and excellent mechanical properties. Further, if the toughened resin composition is blended with other materials, a composite material with excellent properties may be formed.

### EXAMPLES

Hereinafter, the present disclosure will be further described in terms of detailed descriptions and examples, however, it should be understood that these examples are only provided to assist in making the present disclosure easier to understand, as well as to clarify various aspects of the present disclosure and the benefits achieved, and are not intended to limit the scope of the present disclosure.

### Example 1

Six toughened and modified compounds (Example compounds A-F) were prepared according to the present disclosure. Metal foil laminates were subsequently prepared using Example Compounds A-F.

### Example Compound A

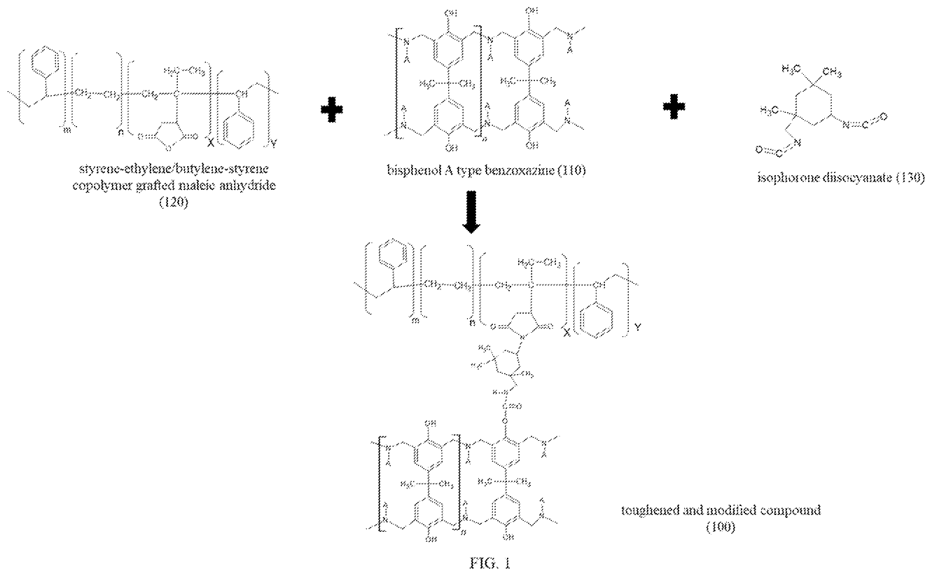

Please refer to the exemplary reaction formula of FIG. 1. In FIG. 1, m, n, X, and Y are the same or different positive integers. 200 g of bisphenol A type benzoxazine (BPA-BZ) 110 and 600 g of toluene were added into a 3-liter four-port separable reaction flask equipped with a heating device, a thermometer, a mixer, and a cooling pipe, the temperature was raised to about 60° C., and stirred uniformly. Under stirring, 20 g of styrene-ethylene/butylene-styrene copolymer grafted maleic anhydride (SEBS-g-MA) 120 was gradually added to the toluene solution within 20 minutes, and the temperature of the synthesis solution was raised to 90° C. to dissolve it completely. Subsequently, about 5 g of isophorone diisocyanate (IPDI) 130 was added, the synthesis solution was heated and gradually raised to about 130° C., and reacted for 1 hour. Then, the heating was stopped and the temperature was lowered to room temperature to obtain Example Compound A, that is, the toughened and modified compound 100.

### Example Compound B

200 g of ODA-BZ and 600 g of toluene were added into a 3-liter four-port separable reaction flask equipped with a heating device, a thermometer, a mixer, and a cooling pipe, the temperature was raised to about 60° C., and stirred uniformly. Under stirring, 20 g of SEBS-g-MA was gradually added to the toluene solution within 20 minutes, and the temperature of the synthesis solution was raised to 90° C. to dissolve it completely. Subsequently, about 5 g of IPDI was added, the synthesis solution was heated and gradually raised to about 130° C., and reacted for 1 hour. Then, the heating was stopped and the temperature was lowered to room temperature to obtain Example Compound B.

### Example Compound C

200 g of BPA-BZ and 600 g of toluene were added into a 3-liter four-port separable reaction flask equipped with a heating device, a thermometer, a mixer, and a cooling pipe, the temperature was raised to about 60° C., and stirred uniformly. Under stirring, 20 g of PP-g-MA was gradually added to the toluene solution within 20 minutes, and the temperature of the synthesis solution was raised to 90° C. to dissolve it completely. Subsequently, about 5 g of IPDI was added, the synthesis solution was heated and gradually raised to about 130° C., and reacted for 1 hour. Then, the heating was stopped and the temperature was lowered to room temperature to obtain Example Compound C.

### Example Compound D

200 g of BPA-BZ and 600 g of toluene were added into a 3-liter four-port separable reaction flask equipped with a heating device, a thermometer, a mixer, and a cooling pipe, the temperature was raised to about 60° C., and stirred uniformly. Under stirring, 20 g of PE-g-MA was gradually added to the toluene solution within 20 minutes, and the temperature of the synthesis solution was raised to 90° C. to dissolve it completely. Subsequently, about 5 g of IPDI was added, the synthesis solution was heated and gradually raised to about 130° C., and reacted for 1 hour. Then, the heating was stopped and the temperature was lowered to room temperature to obtain Example Compound D.

### Example Compound E

200 g of BPA-BZ and 600 g of toluene were added into a 3-liter four-port separable reaction flask equipped with a heating device, a thermometer, a mixer, and a cooling pipe, the temperature was raised to about 60° C., and stirred uniformly. Under stirring, 20 g of SEBS-g-MA was gradually added to the toluene solution within 20 minutes, and the temperature of the synthesis solution was raised to 90° C. to dissolve it completely. Subsequently, about 5 g of HMDI was added, the synthesis solution was heated and gradually raised to about 130° C., and reacted for 1 hour. Then, the heating was stopped and the temperature was lowered to room temperature to obtain Example Compound E.

### Example Compound F

200 g of BPA-BZ and 600 g of toluene were added into a 3-liter four-port separable reaction flask equipped with a heating device, a thermometer, a mixer, and a cooling pipe, the temperature was raised to about 60° C., and stirred uniformly. Under stirring, 20 g of SEBS-g-MA was gradually added to the toluene solution within 20 minutes, and the temperature of the synthesis solution was raised to 90° C. to dissolve it completely. Subsequently, about 5 g of HDI was added, the synthesis solution was heated and gradually raised to about 130° C., and reacted for 1 hour. Then, the heating was stopped and the temperature was lowered to room temperature to obtain Example Compound F.

### Materials

BPA-BZ and ODA-BZ were produced by A.C.R Tech Company; SEBS-g-MA was produced by Taiwan LCY Chemical Corporation; PP-g-MA was produced by ExxonMobil Chemical Company (product number: Exxelor™ PO 1015); and PE-g-MA was produced by ExxonMobil Chemical Company (product number: Exxelor™ PE 1040).

The following Table 1 is the preparation components and contents of the Example Compounds A-F.

TABLE 1

| | | Example Compound | | | | | |
|---|---|---|---|---|---|---|---|
| | | A | B | C | D | E | F |
| Anhydride | SEBS-g-MA | 20 | 20 | | | 20 | 20 |
| grafted olefin | PP-g-MA | | | 20 | | | |
| polymer | PE-g-MA | | | | 20 | | |
| Polybenzoxazine | BPA-BZ | 600 | | 600 | 600 | 600 | 600 |
| compound | ODA-BZ | | 600 | | | | |
| Solvent | Toluene | 600 | 600 | 600 | 600 | 600 | 600 |
| Modifier | IPDA | 5 | 5 | 5 | 5 | | |
| | HMDI | | | | | 5 | |
| | HDI | | | | | | 5 |

### Example 2

The following provides non-limiting methods for preparing the toughened and modified compounds of the present disclosure into metal foil laminates. Ten non-limiting example laminates (Example Laminates 1-10) with the Example Compounds and six comparative example laminates (Comparative Example Laminates 1-6) were prepared according to methods similar to those described below. However, the specific methods for preparing Example Laminates 1-10 and Comparative Example Laminates 1-6 generally differ from the methods disclosed below in one or more respects.

### Example Laminate 1

Preparation of resin composition: 30 g of the solution of Example Compound A was taken, and 5 g of thermosetting resin (BMI), 25 g of CNE epoxy resin and 40 g of solvent (Methyl Ethyl Ketone, MEK) were added, and uniformly mix with a homogenizer to dissolve the components. After all the components were completely dissolved, 40 g of silica was added, and the mixture was continuously mixed and dispersed in the solvent with a homogenizer to prepare a varnish liquid resin composition.

Preparation of prepreg: The reinforcing material glass fiber cloth (substrate E-Glass) was impregnated or coated the above-mentioned varnish liquid resin composition, and the impregnated or coated substrate E-Glass was dried at a temperature of 80° C. for 3 minutes and at a temperature of 180° C. for 7 minutes, thereby a prepreg in a semi-cured state (B-stage) was obtained.

Preparation of metal foil laminate: Four prepregs were laminated, and a 0.5-ounce metal foils (copper foil) was laminated on the outermost layers on both sides, respectively, and then placed in a hot press for high-temperature hot-press curing. The hot-pressing conditions were: heating up to 200° C. to 220° C. with a heating rate of 3.0° C./min, and at this temperature, hot-pressing for 180 minutes at a total pressure of 15 kg/cm² (initial pressure of 8 kg/cm²). Then, a copper foil laminate as Example Laminate 1 was obtained.

### Example Laminates 2-10

Example Laminates 2-10 were prepared according to methods similar to that of Example Laminate 1, however, the methods of preparing Example Laminates 2-10 may differ in one or more aspects as shown in Table 2 below.

Table 2 shows the preparation components and contents of Example Laminates 1-10, as well as the measurement results of physical properties such as adhesive strength, thermal expansion coefficient in the Z-axis direction, and heat resistance of Example Laminates 1-10.

TABLE 2

| | | Example Laminate | | | | | | | | | |
|---|---|---|---|---|---|---|---|---|---|---|---|
| | | 1 | 2 | 3 | 4 | 5 | 6 | 7 | 8 | 9 | 10 |
| Example | A | 30 | | | | | | 20 | 40 | | |
| Compound | B | | 30 | | | | | | | 35 | 40 |
| | C | | | 30 | | | | | | | |
| | D | | | | 30 | | | | | | |
| | E | | | | | 30 | | | | | |
| | F | | | | | | 30 | | | | |
| Thermosetting | BMI | 5 | 5 | 5 | 5 | 5 | 5 | 5 | 5 | 5 | 5 |
| resin | KI-70 | | | | | | | | | | |
| Epoxy resin | CNE epoxy | 25 | 25 | 25 | 25 | 25 | 25 | 35 | 15 | 20 | 15 |
| Filler | SiO₂ | 40 | 40 | 40 | 40 | 40 | 40 | 40 | 40 | 40 | 40 |
| Solvent | MEK | 40 | 40 | 40 | 40 | 40 | 40 | 40 | 40 | 40 | 40 |
| Reinforcing | Glass Cloth | EG | EG | EG | EG | EG | EG | EG | EG | EG | EG |
| material | | | | | | | | | | | |
| Measuring | Tg (TMA) ° C. | 177 | 173 | 176 | 180 | 172 | 172 | 173 | 172 | 172 | 174 |
| physical | Z-CTE % | 2.3 | 2.5 | 2.5 | 2.1 | 2.8 | 2.1 | 2.6 | 2.8 | 2.8 | 2.9 |
| properties | Adhesive | 4.7 | 4.4 | 4.9 | 4.2 | 4.9 | 4.4 | 4.2 | 4.2 | 4.7 | 4.6 |
| | strength lbf/in | | | | | | | | | | |
| | Heat resistance | ◯ | ◯ | ◯ | ◯ | ◯ | ◯ | ◯ | ◯ | ◯ | ◯ |
| | 288° C. | | | | | | | | | | |
| | Heat resistance | ◯ | ◯ | ◯ | ◯ | ◯ | ◯ | ◯ | ◯ | ◯ | ◯ |
| | 300° C. | | | | | | | | | | |

Note:
EG in the table represents E-Glass. The addition unit of each component in the table is grams.

### Comparative Example Laminate 1

Preparation of resin composition: 30 g of BPA-BZ without toughening and modification was taken, and 5 g of thermosetting resin (BMI), 25 g of epoxy resin, 2 g of toughening resin and 40 g of solvent (MEK) were added, and uniformly mix with a homogenizer to dissolve the components. After all the components were completely dissolved, 40 g of silica was added, and the mixture was continuously mixed and dispersed in the solvent with a homogenizer to prepare a varnish liquid resin composition.

Preparation of prepreg: The reinforcing material glass fiber cloth (substrate E-Glass) was impregnated or coated the above-mentioned varnish liquid resin composition, and the impregnated or coated substrate E-Glass was dried at a temperature of 80° C. for 3 minutes and at a temperature of 180° C. for 7 minutes, thereby a prepreg in a semi-cured state (B-stage) was obtained.

Preparation of metal foil laminate: Four prepregs were laminated, and a 0.5-ounce metal foils (copper foil) was laminated on the outermost layers on both sides, respectively, and then placed in a hot press for high-temperature hot-press curing. The hot-pressing conditions were: heating up to 200° C. to 220° C. with a heating rate of 3.0° C./min, and at this temperature, hot-pressing for 180 minutes at a total pressure of 15 kg/cm² (initial pressure of 8 kg/cm²). Then, a copper foil laminate as Comparative Example Laminate 1 was obtained.

### Comparative Example Laminates 2-6

Comparative Example Laminates 2-6 were prepared according to methods similar to that of Comparative Example Laminate 1, however, the methods of preparing Comparative Example Laminates 2-6 may differ in one or more aspects as shown in Table 3 below.

Table 3 shows the preparation components and contents of Comparative Example Laminates 1-6, as well as the measurement results of physical properties such as adhesive strength, thermal expansion coefficient in the Z-axis direction, and heat resistance of Comparative Example Laminates 1-6.

TABLE 3

| | | Comparative Example Laminate | | | | | |
|---|---|---|---|---|---|---|---|
| | | 1 | 2 | 3 | 4 | 5 | 6 |
| BZ without | BPA-BZ | 30 | | 30 | 30 | | |
| modification | ODA-BZ | | 30 | | | 30 | 30 |
| Thermosetting | BMI | 5 | 5 | 5 | 5 | 5 | 5 |
| resin | KI-70 | | | | | | |
| Epoxy resin | CNE epoxy | 25 | 25 | 25 | 25 | 25 | 25 |
| Toughening resin | CSR | 2 | | 4 | 1.5 | 1 | |
| | Ricon 100 | | 2 | | | | 1 |
| Filler | SiO₂ | 40 | 40 | 40 | 40 | 40 | 40 |
| Solvent | MEK | 40 | 40 | 40 | 40 | 40 | 40 |
| Reinforcing | Glass Cloth | EG | EG | EG | EG | EG | EG |
| material | | | | | | | |
| Measuring | Tg (TMA) | 169 | 167 | 158 | 162 | 168 | 167 |
| | ° C. | | | | | | |
| physical | Z-CTE % | 3.4 | 3.1 | 4.1 | 3.3 | 3.5 | 3.8 |
| properties | Adhesive | 4.3 | 4.1 | 4.8 | 4.6 | 4.4 | 4.1 |
| | strength | | | | | | |
| | lbf/in | | | | | | |
| | Heat | ◯ | ◯ | ◯ | X | X | X |
| | resistance | | | | | | |
| | 288° C. | | | | | | |
| | Heat | X | X | X | X | X | X |
| | resistance | | | | | | |
| | 300° C. | | | | | | |

Note:
CSR in the table is the core-shell rubber body. Ricon 100 is a butadiene-styrene copolymer. EG in the table represents E-Glass. The addition unit of each component in the table is grams.

### Materials

BPA-BZ and ODA-BZ were produced by A.C.R Tech Company; the filler SiO₂ was produced by Sibelco (10 μm cut); the thermosetting resin BMI (KI-70) was produced by Daiwa Fine Chemicals Company; CNE epoxy resin was produced by Chang Chun Plastics Company; the reinforcing material was produced by Taiwan Glass industry Corporation (E-Glass glass fabric 2116); the toughening resin CSR was produced by Kaneka Corporation and Ricon 100 was produced by Polyscope Company; and the copper foil was produced Nan Ya Plastics Corporation (H1 0.5 OZ).

### Technical Feature Test

CTE test: According to IPC-TM-650 2.4.24.5 norm, the change rate of the coefficient of thermal expansion in the Z-axis direction (total z-CTE) of the coefficient of thermal expansion (CTE) of the sample to be tested at a temperature below the glass transition temperature (Tg) was measured using a thermal mechanical analyzer (TMA). Z-CTE was measured in the temperature range of 50° C. to 260° C., and the unit is %.

Adhesive strength test: Adhesive strength refers to the adhesion of the metal foil to the laminated prepreg. In this test, the copper foil with a width of ⅛ inch was torn vertically from the board surface, and the strength of the adhesion is expressed by the required force. The unit of tear strength is lbf/in.

Heat resistance test: The dried metal foil laminate was immersed in a solder bath at 288° C. and 300° C. for 100 seconds, and the process was repeated 3 times. Based on the above heat resistance test, “0” was given if the heat resistance is excellent, and “x” was given if there were blisters on the appearance which means that the heat resistance is not good.

From the above results, it can be seen that Example Laminates 1-10 containing the toughened resin composition of the present disclosure show good mechanical properties and heat resistance. In contrast, Comparative Example Laminates 1-6 containing polybenzoxazine compounds without toughening and modification were hard and brittle after cross-linking, and had poor mechanical properties, which cannot be improved even if a large amount of toughening agent or rubber was added externally. Thus, the present disclosure is more suitable for application in a wide range of fields such as composite materials and electronic circuit materials.

In summary, the present disclosure provides a toughened resin composition and a manufacturing method thereof. The toughened resin composition includes a toughened and modified compound, which is a polybenzoxazine compound toughened and modified by an olefin polymer, and formed a chemical bond with a diisocyanate compound. As a result, the toughened resin compound of the present disclosure has excellent heat resistance and mechanical properties. Thus, compared with the related-art polybenzoxazine compound whose mechanical properties are brittle after thermal ring-opening polymerization, the toughened resin composition provided herein is more suitable for use in composite materials, electronic circuit materials, etc. In addition, the toughened resin composition of the present disclosure may also be applied in a wide range of fields such as aerospace, electronic motor, automobile industry and the like.

As used herein and not otherwise defined, the terms “substantially,” “approximately” and “about” are used to describe small variations. When used in conjunction with an event or circumstance, the term can include the exact point at which the event or circumstance occurs, as well as the event or circumstance occurring to a near approximate point. For example, when combined with a numerical value, the term can include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

The above has descripted the components of several examples so that the concepts of the embodiments of the present disclosure may be better understood by those skilled in the art to which the present disclosure pertains. It should be understood by those skilled in the art to which the present disclosure pertains that the embodiments of the present disclosure may be used as a basis for designing or modifying other processes and structures for carrying out the same purposes and/or achieving the same effect as the embodiments described herein. It should also be understood by those skilled in the art to which the present disclosure pertains that these equivalent structures do not depart from the spirit and scope of the present disclosure, and various modifications, alterations, substitutions, and other options can be made without departing from the spirit and scope of the present disclosure. Therefore, the protection scope of the present disclosure shall be determined by the appended claims.

What is claimed is:

1. A toughened resin composition, comprising:
(A) a toughened and modified compound, comprising a polybenzoxazine compound, an anhydride grafted olefin polymer, and a diisocyanate compound; and
(B) a thermosetting polymer;
wherein, in the toughened and modified compound, the diisocyanate compound forms a bond with the polybenzoxazine compound and the anhydride grafted olefin polymer, respectively.

2. The toughened resin composition of claim 1, wherein (A) the toughened and modified compound is 30 to 50 parts by weight; (B) the thermosetting polymer is 8 to 15 parts by weight.

3. The toughened resin composition of claim 1, wherein the thermosetting polymer is bismaleimide (BMI) resin, bismaleimide triazine polymer, cyanate ester polymer, benzocyclobutene polymer, or phenolic resin.

4. The toughened resin composition of claim 1, wherein the polybenzoxazine compound is a bisphenol type polybenzoxazine or a bisamine type polybenzoxazine.

5. The toughened resin composition of claim 1, wherein the polybenzoxazine compound is selected from the group consisting of bisphenol A type benzoxazine, bisphenol F type benzoxazine, bisphenol S type benzoxazine, diaminodiphenylmethane type benzoxazine, diaminodiphenyl ether type benzoxazine and polybenzoxazine with polyimide.

6. The toughened resin composition of claim 1, wherein the anhydride grafted olefin polymer comprises: styrene-ethylene/butylene-styrene copolymer grafted maleic anhydride, polypropylene grafted maleic anhydride or polyethylene grafted maleic anhydride.

7. The toughened resin composition of claim 1, wherein the diisocyanate compound is selected from the group consist of trimethylene diisocyanate, tetramethylene diisocyanate, pentamethylene diisocyanate, hexamethylene diisocyanate, 1,2-propylene diisocyanate, 1,3-butylene diisocyanate, dodecamethylene diisocyanate, 2,4,4-trimethylhexamethylene diisocyanate, 1,3-cyclopentene diisocyanate, 1,3-cyclohexane diisocyanate, 1,4-cyclohexane diisocyanate, methylene dicyclohexyl diisocyanate, isophorone diisocyanate, hydrogenated diphenylmethane diisocyanate, hydrogenated xylylene diisocyanate, hydrogenated toluene diisocyanate, hydrogenated tetramethyl xylylene diisocyanate, phenylene diisocyanate, 2,4-toluene diisocyanate, 2,6-toluene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate and xylylene diisocyanate.

8. The toughened resin composition of claim 1, further comprising: a filler, and the filler is selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene.

9. The toughened resin composition of claim 2, further comprising: a filler, and the filler is selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene.

10. The toughened resin composition of claim 3, further comprising: a filler, and the filler is selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene.

11. The toughened resin composition of claim 4, further comprising: a filler, and the filler is selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene.

12. The toughened resin composition of claim 6, further comprising: a filler, and the filler is selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene.

13. The toughened resin composition of claim 7, further comprising: a filler, and the filler is selected from the group consist of silicon dioxide, aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, barium sulfate, magnesium carbonate, barium carbonate, mica, talc, and graphene.

14. The toughened resin composition of claim 8, wherein the filler is 40 to 60 parts by weight.

15. The toughened resin composition of claim 1, further comprising: a toughening resin of to 15 parts by weight.

16. The toughened resin composition of claim 2, further comprising: a toughening resin of to 15 parts by weight.

17. The toughened resin composition of claim 3, further comprising: a toughening resin of 10 to 15 parts by weight.

18. The toughened resin composition of claim 4, further comprising: a toughening resin of to 15 parts by weight.

19. The toughened resin composition of claim 6, further comprising: a toughening resin of to 15 parts by weight.

20. The toughened resin composition of claim 7, further comprising: a toughening resin of to 15 parts by weight.
